(19) United States
(12) Patent Application Publication
(10) Pub. No.: US 2012/0248638 A1
(43) Pub. Date: Oct. 4, 2012

(54) MOLDING DIES AND METHOD FOR MANUFACTURING SAID MOLDING DIES

(76) Inventor: Hiroyuki Matsuda, Sagamiharu-shi (JP)

(21) Appl. No.: 13/518,684

(22) PCT Filed: Dec. 6, 2010
(86) PCT No.: PCT/JP2010/071798

§ 371 Date: Jun. 22, 2012

(30) Foreign Application Priority Data
Dec. 25, 2009 (JP) 2009-295183

(51) Int. Cl. B29C 45/00; B29D 11/00

(52) U.S. Cl. 264/2.5; 425/577

(57) ABSTRACT

The material of core supporting members (12, 22) is selected such that the thermal expansion coefficient thereof is higher than that of molding sleeves (10, 20). Even when the diameter of openings (10a, 20a) of the molding sleeves (10, 20) is increased due to thermal expansion during transfer molding, the outside diameter of the core supporting members (12, 22) is further increased, gaps between the core supporting members (12, 22) and the openings (10a, 20a) are eliminated. As a result, the optical axes of transfer-molded surfaces formed on cores (13, 23) are accurately positioned with respect to the axes of the openings (10a, 20a), resulting in high-precision optical elements and the like.

### TECHNICAL FIELD

The present invention relates to molding dies and methods for manufacturing said molding dies, and in particular, to molding dies which are suitable for molding optical elements and methods for manufacturing said molding dies.

### BACKGROUND ART

Optical elements, such as lenses, are used in optical devices, such as an optical pick-up device. These optical elements can be manufactured by molding dies, while plastics or glass are used as materials. However, since the optical pick-up devices have been requested to record and reproduce information at high density in recent years, higher accurate optical elements have been requested to be molded.

In general, concerning optical element molding dies for molding objective lenses, for example, an upper molding die and a lower molding die, each of which includes an aspheric surface, are faced each other, melted resin is injected between them, or a preform of heated glass is inserted to be pressed between them, subsequently the resin or the preform is cooled so that objective lenses, exhibiting a desired form, can be manufactured. Further, in order to exchange a deformed transferring molding surface, a core having a transfer surface is fitted within openings which are formed to face the upper and lower molding dies, in some cases. However, even though the openings, facing each other, are formed as accurately as possible, a minute clearance (5 μm, for example), which is necessary for placing and removing the core, exists between the openings and the core, whereby misalignment of an axial line tends to occur between the openings and the core. Due to the misalignment of the axial line, center misalignment of an optical surface of the optical element occurs, so that desired optical functions will not be obtained. This is especially problematic for molding plural optical elements at the same time.

To overcome this problem, Patent Document 1 discloses a technology for positioning plural molding dies, arranged on a stage, onto respective positions, using a piezo element.

### PRIOR ART DOCUMENT

### Patent Document

Patent Document 1: Unexamined Japanese Patent Application No. 2009-167096

### SUMMARY OF THE INVENTION

### Problems to be Solved by the Invention

However, according to the technology disclosed in Patent Document 1, the molding dies are complex and become a major operation, manufactured with high production cost. Accordingly, a simple structure is desired which is able to effectively control the center misalignment of the transferring molding surface.

The present invention has been achieved to solve the current technical problems described above, whereby an object of the present invention is to offer molding dies which are able to control the center misalignment of the molding transferring surfaces as a simple structure, and to offer a method for manufacturing said molding dies.

### Means for Solving the Problem

Molding dies as a first embodiment relating to the present invention including:

at least a pair of molding sleeves including an opening;

a core supporting member including a fitting section configured to fit the opening of at least one of the molding sleeves, and

a core including a molding transferring surface, wherein the core is configured to be connected to the core supporting member,

wherein the molding dies characterizing that the thermal expansion coefficient of the core supporting member is greater than the thermal expansion coefficient of the molding sleeve mounted on the core supporting member.

Due to the heating operation during the transferring molding operation, the core is heated to approximately 400 □, the diameter of the opening of the molding sleeve is widely enlarged due to heat expansion, and the outer diameter of the core is also enlarged. Concerning the structure in the prior art, since the core is directly fitted into the opening of the molding sleeve, the material of general molding sleeve is WC (ultra-hard material), exhibiting a relatively higher thermal expansion coefficient, while the material of the core is also WC (being ultra-hard material) or ceramics, exhibiting relatively lower thermal expansion coefficient, whereby the clearance between the opening of the molding sleeve and the core is enlarged during the transferring molding operation, which results in the misalignment of the center of axis of the core. To overcome said misalignment, if the clearance between the opening of the molding sleeve and the core is reduced, the reduced clearance under normal temperature results in difficult assembling work to fit the core into the opening. If the operator wants the core formed of a material exhibiting lower thermal expansion coefficient, the operator further needs to have the molding sleeve formed of a material exhibiting a further lower thermal expansion coefficient, it is difficult for the operator to determine a material exhibiting acceptable characteristics other than the thermal expansion coefficient.

Accordingly, in the present invention, the core supporting member is placed between the opening of the molding sleeve and the core, and the material of the core supporting member is determined so that the thermal expansion coefficient of said core supporting member is greater than that of the molding sleeve. Due to this determination, at normal temperature, the clearance between the core and the core supporting member is effective in fitting them into each other, and during the transfer molding operation, the outer diameter of the core supporting member increases to be greater than the thermal expansion of the opening diameter of the molding sleeve, whereby the fitting clearance is effectively cancelled, and a molding transfer surface formed on the core can be positioned against the opening at high accuracy, so that optical elements exhibiting high accuracy can be formed.

Specifically, concerning members of a core having molding optical surfaces, desired materials are limited to be used regarding the forming condition. For example, SiC may be optimum as the material of the core, since the thermal expansion coefficient of said SiC is relatively low, if the operator wants to infill the fitting clearance using the thermal expansion, the operator must use a material for the molding sleeve exhibiting a further lower thermal expansion coefficient. However, though there are materials exhibiting a thermal expansion coefficient lower than SiC, considering said materials to be used as a practical matter, the operator cannot help but consider conditions other than the thermal expansion coefficient, whereby it is difficult for the operator to determine the material. At the same time, while changing the viewpoint, since SiC is necessary on the molding transfer surface, SiC is not necessary to be used on the fitting section. Consequently, the structure of a pin is divided into a section having a function necessary for transferring the optical surface, and a section having a function for infilling the fitting clearance formed by thermal expansion, whereby the problem as to misalignment of the axial line can be overcome, even though SiC is used. Due to this, while an aligning structure, using the thermal expansion, is used, materials to be used for the optical surface can be more freely determined, so that molding dies, which are more effective for the molding operation can be manufactured.

Further, it is preferable that the thermal expansion coefficient of the core supporting member is more than two times that of the thermal expansion coefficient of the molding sleeve, mounted on said core supporting member. Due to the above described structure, the clearance necessary for fitting can be obtained, and the clearance is simultaneously eliminated by the thermal expansion.

Still further, it is preferable that plural openings are formed on the molding sleeve. Due to this structure, since the position of the core to be mounted on each opening can be determined, the positions of the plural molding cores can be easily adjusted.

Still further, it is preferable that among the paired molding sleeves, an opening of the molding sleeve and an opening of another molding sleeve are mechanically manufactured at the same time. Due to this, the relative position of both openings can be theoretically determined, and the position of the core against the opening can be determined on the shaft of the opening at high accuracy, so that a very precise molding operation can be conducted. As the mechanical manufacturing process, a through-hole process, conducted by drilling or electric discharging work, is preferable, but is not limited to these.

Still further, it is preferable that the core and the core supporting member are adhered to each other. A mechanical fixture using screws is preferable to make it work.

Still further, it is preferable that the outer diameter of the fitting section of the core supporting member is less than the greatest outer diameter of the core at normal temperature, and the outer diameter of the fitting section of the core supporting member becomes greater than the greatest outer diameter of the core, during the molding work. Due to this structure, the difference, between the outer diameter of the core after thermal expansion and the outer diameter of the core supporting member, can be minimized, so that the clearance between the opening section of the molding sleeve and the core can be minimized.

Still further, it is preferable that the material of the molding sleeve is WC, the material of the core supporting member is STAVAX, and the material of the core is SiC.

Concerning a production method of the molding die of the first embodiment relating to the present invention, wherein the molding dies include:

at least a pair of molding sleeves including an opening;

a core supporting member including a fitting section configured to fit the opening of at least one of the molding sleeves, and

a core including a molding transferring surface which is configured to be connected to the core supporting member,

wherein the molding dies characterizing that the thermal expansion coefficient of the core supporting member is greater than the thermal expansion coefficient of the molding sleeve mounted on the core supporting member,
wherein the production method of the molding die includes a step of mechanically manufacturing the opening of one molding sleeve of at least a pair of molding sleeves, and the opening of an other molding sleeve, at the same time.

Based on the present invention, the relative position of both openings can be theoretically determined, and the position of the core against the opening can be determined on the axis of the opening at high accuracy, so that the molding operation can be conducted at an equally high accuracy.

### Effect of the Invention

According to the present invention, the molding dies and the method of manufacturing said molding dies can be offered, in which the center misalignment of the transferring molding surface can be effectively controlled.

### BRIEF DESCRIPTIONS OF THE DRAWINGS

FIG. 1 is a cross-sectional view of molding dies, in which FIG. 1a shows the molding dies being opened, while FIG. 1b shows the molding dies being closed to each other.

FIG. 2 shows a core and a core supporting member.

FIG. 3 is a perspective view to show a condition for manufacturing a molding sleeve.

FIG. 4 shows a core and a core supporting member as another embodiment.

FIG. 5 shows a core and a core supporting member as still another embodiment.

### PREFERRED EMBODIMENT OF THE INVENTION

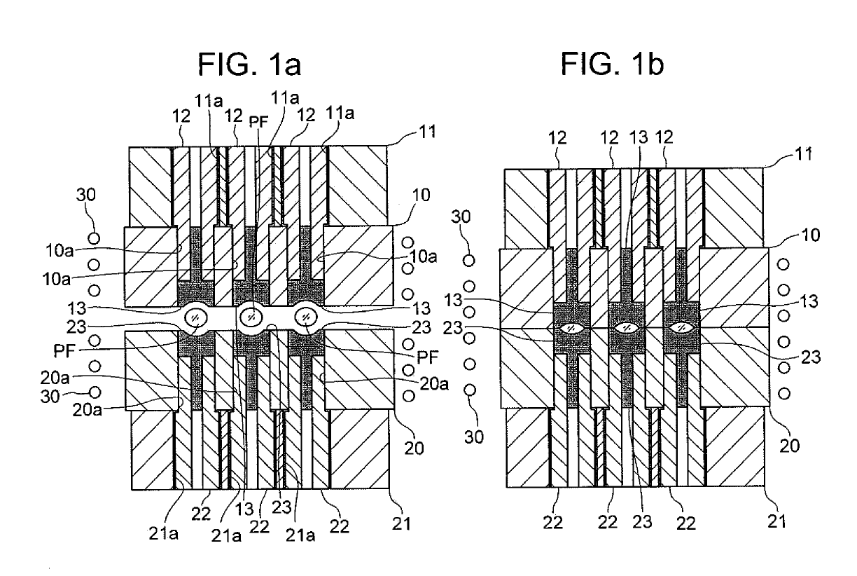

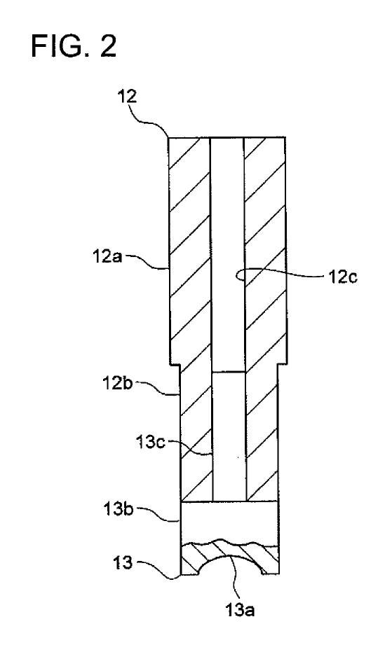

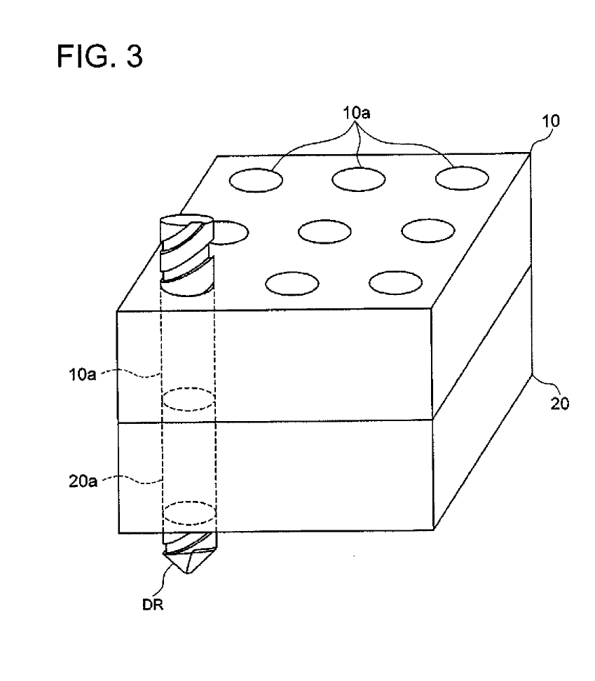

Embodiments of the present invention will now be detailed while referring to the drawings. FIG. 1 is a cross-sectional view of the molding dies, FIG. 2 shows the core and the core supporting member, and FIG. 3 is the perspective view to show a condition for manufacturing the molding sleeve.

In FIG. 1, upper die (being the molding sleeve) 10 includes plural cylindrical openings 10a, (they are aligned in 3 rows and 3 columns in this case). Core supporting member 12 is fitted into opening 10a. Upper molding die 10 is formed of a material, being WC, whose thermal expansion coefficient is 5.7×10⁻⁶/K.

As shown in FIG. 2, hollow cylindrical core supporting member 12 is formed of large diameter section 12a and small diameter section 12b (which are fitting sections), both sections are aligned straightly to be integrated on each other, having through hole 12c in the axial direction, wherein said member 12 is formed of STAVAX (which is a pre-hardened steel). The thermal expansion coefficient of STAVAX is 1.2×10⁻⁵/K.

In FIG. 2, core 13 includes head section 13b carrying molding transfer surface 13a on an end surface, and shaft section 13c being connected to head section 13b. Cylindrical shaft section 13c, inserted into through hole 12c of small diameter section 12b, is fixed by heat resistant adhesive agent, so that core 13 can be mounted on the end of core supporting member 12. Core 13 is formed of SiC (which is silicon carbide), whose thermal expansion coefficient is 7×10⁻⁶/K.

In FIG. 1, upper molding die (which is a molding sleeve) 10, supported by lower holder 21, includes plural cylindrical openings 20a (which are aligned in 3 rows and 3 columns). Core supporting member 22 is fitted into opening 20a. Lower molding die 20 is formed of WC, in the same way as upper molding die 10.

Hollow cylindrical core supporting member 22 is shaped to be the same as core supporting member 12, said member 22 is formed of STAAX (which is a pre-hardened steel). Further, core 23 is shaped to be the same as core 13, and mounted on core supporting member 22. Core 23 is formed of SIC (which is silicon carbide).

When opening 10a of upper molding die 10 and opening 20a of lower molding die 20 are formed, as shown in FIG. 3, upper molding die 10 and lower molding die 20 are positioned based on an alignment mark, which is not illustrated, and stacked on each other, whereby opening 10a and opening 20a are formed at one time by drill DR into opening 10a and opening 20a, which is a preferable way. Due to this way, openings 10a and 20a can be formed concentrically.

After that, opening 10a and opening 20a are separated to each other, small diameter sections 12b of core supporting members 12, on each of which core 13 has been mounted, are subsequently fitted onto openings 10a of upper molding die 10 mounted on upper holder 11. In the same way, small diameter sections 22b of core supporting members 22, on each of which core 23 has been mounted, are subsequently fitted onto openings 20a of lower molding die 20 mounted on lower holder 21. After that, plural openings 10a and 20a, facing each other, are aligned concentrically. By the above works, a relatively great clearance is formed between opening 11a of upper holder 11 and large diameter section 12a of core supporting member 12, and a relatively great clearance is formed between opening 21a of upper holder 21 and large diameter section 22a of core supporting member 22.

Next, a molding operation using the molding dies of the present embodiment will be detailed. As shown in FIG. 1(a), after upper molding die 10 and lower molding die 20 are separated to each other, they are heated by exterior coil 30, and glass pre-form PF is arranged between the molding transferring surfaces, facing each other. Further, as shown in FIG. 1(b), upper molding die 10 and lower molding die 20 are made to approach each other, so that pre-form PF is pressured to change its form by the molding transferring surfaces. Due to these operations, the form of the molding transferring surface is transferred onto pre-form PF with high dimensional accuracy. After the molding dies are cooled, upper molding die 10 and lower molding die 20 are separated each other, plural optical elements, having been molded, can be subsequently removed.

According to the present embodiment, the materials, used for core supporting members 12 and 22 whose thermal expansion coefficients are greater than those of molding sleeves 10 and 20, are selected to be determined for use, and the exterior diameters of core supporting members 12 and 22, as well as the opening diameter of molding sleeves 10 and 20 are determined, so that their desired sizes are obtained during the transferring molding temperature. During the transfer molding operation, opening diameters 10a and 20a of molding sleeves 10 and 20 increase due to the thermal expansion, however, the external diameters of core supporting members 12 and 22 also increase to be greater than opening diameters 10a and 20a, whereby the clearances against openings 10a and 20a are eliminated. Accordingly, the molding transfer surfaces formed on cores 13 and 23 can be positioned at high accuracy against openings 10a and 20a which are aligned concentrically, so that very accurate optical elements can be produced.

According to the present embodiment, at the normal temperature, the external diameters of small diameter sections 12b of core supporting members 12 and 22 are determined to be less than the greatest external diameters of cores 13 and 23, and during the molding operation, the external diameters of small diameter sections 12b of core supporting members 12 and 22 are determined to be greater than the greatest external diameters of cores 13 and 23. Since such cores 13 and 23 and such core supporting members 12 and 22 are used, during the molding heating operation, core supporting members 12 and 22, which are used for the fitting sections, expand to be greater than openings 10a and 20a of molding sleeves 10 and 20, so that the fitting clearances can be minimized, or decreased to be negligible small conditions. That is, axial misalignments between openings 10a and 20a and cores 13 and 23 can be effectively controlled to be nearly zero.

This method can produce more effects on molding sleeves carrying multiple surfaces which can set plural cores 13 and 23, on paired molding sleeves 10 and 20 for molding both surfaces of the molded lenses. In case of the molding sleeves carrying multiple surfaces, it is important that axial line of cores 13 and 23 facing each other are controlled to be the same. Accordingly, by the simultaneous production of openings 10a and 20a of paired molding sleeves 10 and 20, the positions of openings 10a and 20a can be perfectly conform. Further, since core supporting members 13 and 23 of the present embodiment are used, the axial lines of cores 13 and 23 also nearly conform, whereby every molding product can be produced at high accuracy. That is, according to the present embodiment, the prior technical problems can be solved. Said problem means that when each core adversely moves in the scope of fitting clearance, though the axial position of a molding product existing on one position may be corrected, the axial positions of molding products at other positions cannot be corrected.

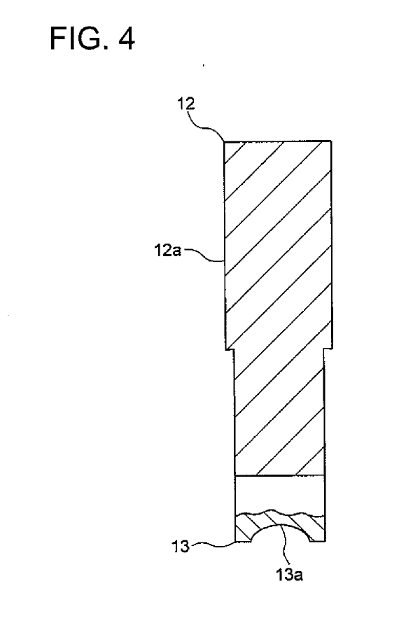

FIG. 4 shows a core and a core supporting member of another embodiment. In this embodiment, core supporting member 12 is formed to be solid, and core 13 exhibiting a short cylinder is adhered onto the end of core supporting member 12. According to this embodiment, the positional misalignment, which is due to inherent difference of thermal expansion, can be effectively controlled, in a direction perpendicular to the axial line of core 13 and core supporting member 12.

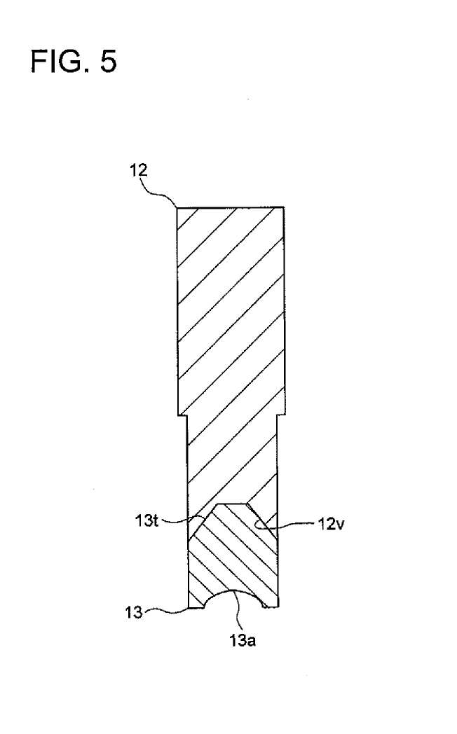

FIG. 5 shows a core and a core supporting member as still anther embodiment. In this embodiment, tapered concave section 12v is formed on the end face of core supporting member 12, and tapered convex section 13t is formed on the end face of core 13. Since convex section 13t is fitted into concave section 12v, center alignment for core 13 can be conducted against core supporting member 12, whereby, under this aligned condition, both sections are adhered to each other.

### INDUSTRIAL AVAILABILITY

The present invention is not limited to the embodiments detailed in this specification, but the present invention can also include other embodiments or variations, which will be clear to persons skilled in the art of the present field, while studying the embodiments and the technical idea. The present invention is not limited to the transferring molding work of glass materials, but the present invention can also be applied to injection molding of resin materials, for example.

### EXPLANATION OF ALPHA-NUMERICAL SYMBOLS

10 upper molding die
10a opening
11 upper holder
11a opening
12 core supporting member
12a large diameter section
12b small diameter section
13 core
13a molding transferring section
13b head section
13c shaft section
20 lower molding die
20a opening
21 lower holder
21a opening
22 core supporting member
23 core
30 coil
DR drill
PF pre-form

1.-8. (canceled)

9. Molding dies comprising:
at least a pair of molding sleeves, including plural openings;
plural core supporting members, each including fitting sections configured to fit the plural openings of at least one of the molding sleeves, and
plural cores, each including a molding transferring surface, wherein the plural cores are configured to be connected to each of the plural core supporting members,
wherein a thermal expansion coefficient of the plural core supporting members is greater than a thermal expansion coefficient of the molding sleeve mounted on the core supporting members, and
wherein of at least a pair of the molding sleeves, an opening of one molding sleeve and an opening of another molding sleeve to be stacked on the opening of said one molding sleeve are mechanically manufactured at one time.

10. The molding dies of claim 9, wherein the thermal expansion coefficient of the core supporting member is more than two times greater than the thermal expansion coefficient of the molding sleeve mounted on the core supporting member.

11. The molding dies of claim 9, wherein a tapered concave section is formed on an end face of the core supporting member, and a tapered convex section is formed on an end face of core, so that the tapered concave section and the tapered convex section are adhered to fit to each other.

12. The molding dies of claim 9, wherein the core supporting member is inserted into the opening of the molding sleeve, from an opposite side of a facing surface against the other molding sleeve.

13. The molding dies of claim 9, wherein the core is adhered onto the core supporting member.

14. The molding dies of claim 9, wherein
at a normal temperature, an external diameter of a fitting section of the core supporting member is configured to be less than a greatest external diameter of the core, and
during a molding operation, the external diameter the fitting section of the core supporting member is configured to be greater than the greatest external diameter of the core.

15. The molding dies of claim 9, wherein a material of the molding sleeve comprises WC, a material of the core supporting member comprises STAVAX, and a material of the core comprises SiC.

16. A method for producing molding dies for molding optical elements, wherein the molding dies comprising:
at least a pair of molding sleeves including plural openings;
plural core supporting members including a fitting section configured to fit plural openings of at least one of the molding sleeves, and
a core including a molding transferring surface, wherein the core is configured to be connected to the core supporting member,
wherein the thermal expansion coefficient of the core supporting members is greater than the thermal expansion coefficient of the molding sleeve mounted on the core supporting members, wherein the method for producing the molding dies for molding the optical elements includes a step of mechanically manufacturing at one time the opening of one molding sleeve and the opening of the other molding sleeve to be stacked on the opening of said one molding sleeve, of at least one pair of the molding sleeves.

17. The method for producing the molding dies for molding the optical elements of claim 16,
wherein a molding material is applied onto molding transfer surfaces of the molding dies, so that the molding material is molded.

18. The method for producing the molding dies for molding the optical elements of claim 16,
wherein the molding material comprises glass.
